(19) United States
(12) Patent Application Publication
(10) Pub. No.: US 2008/0016248 A1
(43) Pub. Date: Jan. 17, 2008

(54) Method and apparatus for time synchronization of parameters

(76) Inventors: George Tsirtsis, New York, NY (US); Vincent D. Park, Budd Lake, NJ (US)

Correspondence Address: QUALCOMM INCORPORATED, 5775 MOREHOUSE DR., SAN DIEGO, CA, 92121, US

(21) Appl. No.: 11/486,713

(22) Filed: Jul. 14, 2006

(51) Int. Cl. G06F 15/16

(52) U.S. Cl. 709/248

(57) ABSTRACT

An apparatus and method for time synchronizing one or more parameters in a communication system is provided, wherein the apparatus generates a request message for requesting time synchronization of a parameter, the request message comprises a transaction ID, a requested parameter, and an index value associated with the requested parameter, transmits the generated request message to a first node and receives a response message from the first node, the response message comprises an index associated with the requested parameter and a response value.

### FIELD

This invention relates to communications system and, more particularly, synchronizing parameters between two or more nodes operating in a communication system.

### BACKGROUND

Wireless communication systems have become a prevalent means to communicate with others worldwide. Wireless communication devices, such as cellular telephones, personal digital assistants, and the like have become smaller and more powerful in order to meet consumer needs and to improve portability and convenience. Consumers have become dependent upon these devices, demanding reliable service, expanded areas of coverage, additional services (e.g., web browsing capabilities), and continued reduction in size and cost of such devices.

A typical wireless communication (e.g., employing frequency, time, and code division techniques) includes one or more base stations that provides coverage areas to subscribers as well as mobile (e.g., wireless) devices that can transmit and receive data within the coverage areas. A typical base station can simultaneously transmit multiple data streams to multiple devices for broadcast, multicast, and/or unicast services, wherein a data stream is a stream of data that can be of independent reception interest to a user device. A user device within the coverage area of that base station can be interested in receiving one, more than one or all the data streams carried by the composite stream. Likewise, a user device can transmit data to the base station or another user device.

In a typical communication system, several nodes, for example mobile terminal, base station and network servers (home agents) communicate with each other. A mobile terminal communicates with base station via a wireless link. The base station may be in communication with network servers via either wired or wireless link.

At each node there are several processes that operate in parallel for robustness of the wireless communication system. Each of these processes maintain set of parameter values. The use of these parameters must be synchronized between two nodes (i.e. a mobile terminal and base station) in order to maintain robustness of the system. The synchronization is achieved by negotiating the parameters (e.g. encryption keys) and negotiating time of activation (e.g. time when the parameters become effective). In wireless communication, several parameters require negotiation in order to maintain synchronization between the two nodes.

Typically, a mobile terminal will initiate a request for one or more parameter and a preferred time of activation. The mobile terminal will generate a message and include a parameter and a time of activation and transmit the message to the base station. Prior to transmission, the mobile terminal will either request new physical resources (communication channel) or use existing physical resources to transmit the request. In response, the base station will either request a new resource or use an existing resource to reply to the request. The base station will either provide acknowledgement or will reject the request. If the time request was rejected, the mobile terminal will send another message to request another time for the same parameters.

In a typical communication system, the request-reply occurs for every parameter that needs to be negotiated. Depending on the use of the nodes, several parameters are negotiated throughout the operation for maintaining synchronization. In a communication system (i.e. wireless communication system) having a limited bandwidth, the request-reply communications for each parameter are a burden on the system and may cause the system to be inefficient. Therefore, an efficient method is needed for time synchronizing of the parameters between two or more nodes.

### SUMMARY

In accordance with various embodiments, an apparatus for time synchronizing one or more parameters in a communication system is disclosed, wherein the apparatus generates a request message for requesting time synchronization of a parameter, the request message comprises a transaction ID, a requested parameter, and an index value associated with the requested parameter, transmits the generated request message to a first node and receives a response message from the first node, the response message comprises an index associated with the requested parameter and a response value.

In another aspect, an apparatus for time synchronizing one or more parameters in a communication system is disclosed, wherein the apparatus receives a request message, the request message comprises a transaction ID, a requested parameter, and an index value associated with the requested parameter, and generates a response message, the response message comprises an index associated with the requested parameter and a response value associated with the requested parameter.

A more complete appreciation of all the advantages and scope of the aspect can be obtained from the accompanying drawings, the description and the appended claims.

### BRIEF DESCRIPTION OF THE DRAWINGS

FIG. 1 illustrates a network diagram of an exemplary communications system;

FIG. 2 illustrates an exemplary access terminal;

FIG. 3 illustrates an exemplary access point;

FIG. 4 is a high level block diagram of a system that is provided to illustrate configuration of a host;

FIG. 5 illustrates message transmitted by a requesting node.

FIG. 6 illustrates message transmitted by the requested node in response to receiving a request message;

FIG. 7 illustrates the signaling between two nodes.

FIG. 8 illustrates a flow routine executed by a processor;

FIG. 9 illustrates a flow routine executed by a processor;

FIG. 10 illustrates a flow routine executed by processor for processing received response message;

FIG. 11A and FIG. 11B illustrates the use of one or more modules to carry out the methodologies 1100 and 1150 according to an aspect of some embodiments.

### DETAILED DESCRIPTION

This aspect relates to communications system and, more particularly, to methods and apparatus for supporting quality of service differentiation between traffic flows in a communication system

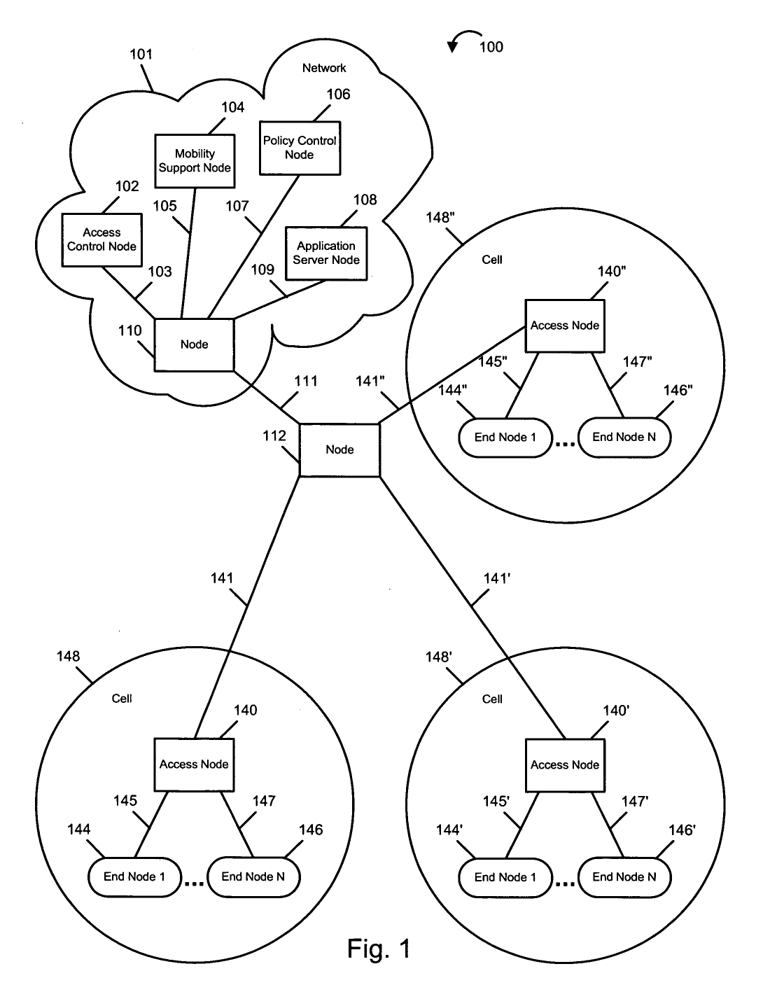

FIG. 1 illustrates an exemplary communication system 100 implemented in accordance with an aspect, e.g., a cellular communication network, which comprises a plurality of nodes interconnected by communications links. The network may use Orthogonal Frequency Division Multiplexing (OFDM) signals to communicate information over wireless links. However, other types of signals, e.g., Code Division Multiple Access (CDMA) signals or Time Division Multiple Access (TDMA) signals, might be used instead. Nodes in the exemplary communication system 100 exchange information using signals, e.g., messages, based on communication protocols, e.g., the Internet Protocol (IP). The communications links of the system 100 may be implemented, for example, using wires, fiber optic cables, and/or wireless communications techniques. The exemplary communication system 100 includes a plurality of end nodes (also referred to as access terminals) 144, 146, 144′, 146′, 144″, 146″, which access the communication system via a plurality of access nodes (also referred to as access points) 140, 140′, 140″. The access terminals 144, 146, 144′, 146′, 144″, 146″ may be, e.g., wireless communication devices or terminals, and the access points 140, 140′, 140″ may be, e.g., wireless access routers or base stations. The exemplary communication system 100 also includes a number of other nodes 102, 104, 106, 108, 110, and 112, used to provide interconnectivity or to provide specific services or functions.

The FIG. 1 exemplary system 100 depicts a network 101 that includes an access control node 102, a mobility support node 104, a policy control node 106, and an application server node 108, all of which are connected to an intermediate network node 110 by a corresponding network link 103, 105, 107, and 109, respectively. In some embodiments, the access control node, e.g., a Remote Authentication Dial In User Service (RADIUS) or Diameter server, supports authentication, authorization, and/or accounting of access terminals and/or services associated with access terminals. In some embodiments, the mobility support node, e.g., a Mobile IP home agent and/or context transfer server, supports mobility, e.g., handoff, of access terminals between access points, e.g., via redirection of traffic to/from access terminals and/or transfer of state associated with access terminals between access points. In some embodiments, the policy control node, e.g., a policy server or Policy Decision Point (PDP), supports policy authorization for services or application layer sessions. In some embodiments, the application server node, e.g., a Session Initiation Protocol server, streaming media server, or other application layer server, supports session signaling for services available to access terminals and/or provides services or content available to access terminals.

The intermediate network node 110 in the network 101 provides interconnectivity to network nodes that are external from the perspective of the network 101 via network link 111. Network link 111 is connected to another intermediate network node 112, which provides further connectivity to a plurality of access points 140, 140′, 140″ via network links 141, 141′, 141″, respectively.

Each access point 140, 140′, 140″ is depicted as providing connectivity to a plurality of N access terminals (144, 146), (144′, 146″), (144″, 146″), respectively, via corresponding access links (145, 147), (145′, 147′), (145″, 147″), respectively. In the exemplary communication system 100, each access point 140, 140′, 140″ is depicted as using wireless technology, e.g., wireless access links, to provide access. A radio coverage area, e.g., communications cell, 148, 148′, 148″ of each access point 140, 140′, 140″, respectively, is illustrated as a circle surrounding the corresponding access point.

The exemplary communication system 100 is subsequently used as a basis for the description of various embodiments. Alternative embodiments of the aspect include various network topologies, where the number and type of nodes (including network nodes, access points, access terminals, as well as various control, support, and server nodes), the number and type of links, and the interconnectivity between various nodes may differ from that of the exemplary communication system 100 depicted in FIG. 1.

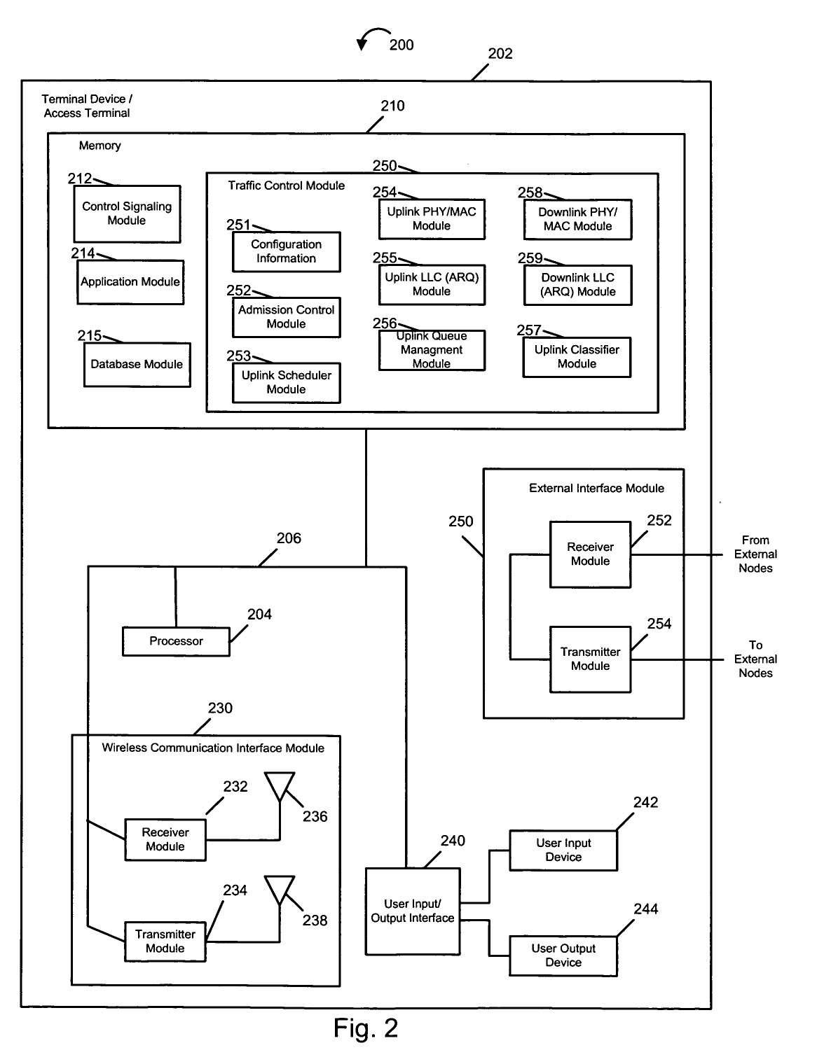

FIG. 2 provides a detailed illustration of an exemplary access terminal 200, e.g., wireless terminal. The exemplary access terminal 200, depicted in FIG. 2, is a detailed representation of an apparatus that may be used as any one of the access terminals 144, 146, 144′, 146′, 144″, 146″, depicted in FIG. 1. According to an aspect, in the FIG. 2 embodiment, the access terminal 200 includes a processor 204, a wireless communication interface module 230, a user input/output interface 240 and memory 210 coupled together by bus 206. Accordingly, via bus 206 the various components of the access terminal 200 can exchange information, signals and data. The components 204, 206, 210, 230, 240 of the access terminal 200 are located inside a housing 202.

The wireless communication interface module 230 provides a mechanism by which the internal components of the access terminal 200 can send and receive signals to/from external devices and network nodes, e.g., access points. The wireless communication interface module 230 includes, e.g., a receiver module 232 with a corresponding receiving antenna 236 and a transmitter module 234 with a corresponding transmitting antenna 238 used for coupling the access terminal 200 to other network nodes, e.g., via wireless communications channels.

The exemplary access terminal 200 also includes a user input device 242, e.g., keypad, and a user output device 244, e.g., display, which are coupled to bus 206 via the user input/output interface 240. Thus, user input/output devices 242, 244 can exchange information, signals and data with other components of the access terminal 200 via user input/output interface 240 and bus 206. The user input/output interface 240 and associated devices 242, 244 provide a mechanism by which a user can operate the access terminal 200 to accomplish various tasks. In particular, the user input device 242 and user output device 244 provide the functionality that allows a user to control the access terminal 200 and applications, e.g., modules, programs, routines and/or functions, that execute in the memory 210 of the access terminal 200.

The processor 204 under control of various modules, e.g., routines, included in memory 210 controls operation of the access terminal 200 to perform various signaling and processing. The modules included in memory 210 are executed on startup or as called by other modules. Modules may exchange data, information, and signals when executed. Modules may also share data and information when executed. In the FIG. 2 embodiment, the memory 210 of access terminal 200 of the includes a control signaling module 212, an application module 214, and a traffic control module 250, which further includes configuration information 251 and various additional modules 252, 253, 254, 255, 256, 257, 258, and 259.

The control signaling module 212 controls processing relating to receiving and sending signals, e.g., messages, for controlling operation and/or configuration of various aspects of the access terminal 200 including, e.g., the traffic control module 250 as well as the configuration information 251 and the various additional modules included therein 252 ,253 ,254, 255, 256, 257, 258, and 259. In some embodiments of the, the control signaling module 212 includes state information, e.g., parameters, status and/or other information, relating to operation of the access terminal 200 and/or one or more signaling protocols supported by the control signaling module 212. In particular, the control signaling module 212 may include configuration information, e.g., access terminal identification information and/or parameter settings, and operational information, e.g., information about current processing state, status of pending message transactions, etc.

The application module 214 controls processing and communications relating to one or more applications supported by the access terminal 200. In some embodiments of the aspect, application module 214 processing includes tasks relating to input/output of information via the user input/output interfaces 240, manipulation of information associated with an application, and/or receiving or sending signals, e.g., messages, associated with an application. In some embodiments, the application module 214 includes state information, e.g., parameters, status and/or other information, relating to operation of one or more applications supported by the application module 214. In particular, the application module 214 may include configuration information, e.g., user identification information and/or parameter settings, and operational information, e.g., information about current processing state, status of pending responses, etc. Applications supported by the application module 214 include, e.g., Voice over IP (VoIP), web browsing, streaming audio/video, instant messaging, file sharing, gaming, etc.

The database module 215 holds the information about the processes according to an aspect of some embodiments. For example, the database module 215 is used to storing the designated transmit process, an event look-up table, process registration information, a temporary holding place for envelopes, parameter valued, etc.

The traffic control module 250 controls processing relating to receiving and sending data information, e.g., messages, packets, and/or frames, via the wireless communication interface module 230. The exemplary traffic control module includes configuration information 251 as well as various additional modules 252, 253, 254, 255, 256, 257, 258, and 259 that control various aspects of quality of service for packets and/or traffic flows, e.g., associated sequences of packets. In some embodiments, the traffic control module 250 includes state information, e.g., parameters, status and/or other information, relating to operation of the access terminal 200, the traffic control module 250, and/or one or more of the various additional modules included therein 252, 253, 254, 255, 256, 257, 258, and 259. The configuration information 251, e.g., parameter settings, determines, affects and/or prescribes operation of the traffic control module 250 and/or the various additional modules included therein 252, 253, 254, 255, 256, 257, 258, and 259. The various additional modules are included, in some embodiments, to perform particular functions and operations as needed to support specific aspects of traffic control. In various embodiments, modules may be omitted and/or combined as needed depending on the functional requirements of traffic control. A description of each additional module included in the exemplary traffic control module 250 follows.

The admission control module 252 maintains information relating to resource utilization/availability and determines if sufficient resources are available to support the quality of service requirements of particular traffic flows. Resource availability information maintained by the admission control module 252 includes, e.g., packet and/or frame queuing capacity, scheduling capacity, as well as processing and memory capacity needed to support one or more traffic flows. The control signaling module 212, application module 214, and/or other modules included in the access terminal 200 may, and in some embodiments do, query the admission control module 252 to determine if sufficient resources are available to support a new or modified traffic flow, where the admission control determination is a function of the quality of service requirements of the particular traffic flow and/or the available resources. The configuration information 251 may, and in some embodiments does, include configuration information, e.g., parameters settings, that affect the operation of the admission control module 252, e.g., an admission control threshold value that indicates the percentage of resource that may be allocated prior to rejecting additional requests.

The uplink scheduler module 253 controls processing relating to transmission scheduling, e.g., order and/or timing, and allocation of transmission resources, e.g., information coding rate, transmission time slots, and/or transmission power, for data information, e.g., messages, packets, and/or frames, to be sent via the wireless interface module 230, e.g., from the access terminal 200 to an access point. The uplink scheduler module 253 may, and in some embodiments does, schedule transmissions and allocate transmission resources as a function of the quality of service requirements and/or constraints associated with one or more traffic flows. The configuration information 251 may, and in some embodiments does, include configuration information, e.g., parameters settings, that affect the operation of the uplink scheduler module 253, e.g., a priority, rate bound, latency bound, and/or sharing weight associated with one or more traffic flows. In some embodiments of the aspect, scheduling and/or resource allocation operations performed by the uplink scheduler module 253 are additionally a function of channel conditions and other factors, e.g., power budget.

The uplink PHY/MAC module 254 controls physical (PHY) layer and Media Access Control (MAC) layer processing relating to sending data information, e.g., messages, packets, and/or frames, via the wireless communication interface module 230, e.g., from the access terminal 200 to an access point. In some embodiments of the aspect, operation of the uplink PHY/MAC module 254 includes both sending and receiving control information, e.g., signals or messages, to coordinate sending of data information, e.g., messages, packets, or frames. The configuration information 251 may, and in some embodiments does, include configuration information, e.g., parameters settings, that affect the operation of the uplink PHY/MAC module 254, e.g., a frequency, band, channel, spreading code or hoping code to be used for transmissions, an identifier associated with the access terminal 200, a request dictionary prescribing use of an assignment request channel, etc.

The uplink Logical Link Control (ARQ) module 255 controls Logical Link Control (LLC) layer processing relating to sending data information, e.g., messages, packets, and/or frames, via the wireless communication interface module 230, e.g., from the access terminal 200 to an access point. The uplink LLC (ARQ) module 255 includes processing associated with Automatic Repeat Request (ARQ) capabilities, e.g., retransmission of lost packets or frames. In some embodiments of the aspect, the uplink LLC (ARQ) module 255 further includes processing relating to the addition of an LLC header and/or trailer to higher layer messages, e.g., packets, to provide additional functionality, e.g., multi-protocol multiplexing/demultiplexing via a type field or error detection via a checksum field. The uplink LLC (ARQ) module 255 may also, and in some embodiments does, perform fragmentation of higher layer messages, e.g., packets, into multiple sub-portions, e.g., frames to be sent by the uplink PHY/MAC module 254. The configuration information 251 may, and in some embodiments does, include configuration information, e.g., parameters settings, that affect the operation of the uplink LLC (ARQ) module 255, e.g., an ARQ window size, maximum number of retransmissions, a discard timer, etc.

The uplink queue management module 256 maintains information and controls processing relating to storage of data information, e.g., messages, packets, and/or frames, to be sent via the wireless communication interface module 230, e.g., from the access terminal 200 to an access point. The uplink queue management module 256 may, and in some embodiments does, control storage of data information awaiting transmission and maintain state information regarding data information awaiting transmission on a per traffic flow basis, e.g., packets associated with each traffic flow may be stored in separate queues. In some embodiments of the aspect, the uplink queue management module 256 supports a variety of queue management techniques and/or capabilities, e.g., head drop, tail drop, as well as various Active Queue Management (AQM) mechanisms such as Random Early Detection (RED). The configuration information 251 may, and in some embodiments does, include configuration information, e.g., parameters settings, that affect the operation of the uplink queue management module 256, e.g., a queue limit, drop strategy, and/or AQM thresholds associated with one or more traffic flows.

The uplink classifier module 257 controls processing relating to identification of data information, e.g., messages, packets, and/or frames, as belonging to particular traffic flows prior to being sent via the wireless communication interface module 230, e.g., from the access terminal 200 to an access point. In some embodiments of the aspect, messages, packets, and/or frames to be sent via the wireless communication interface module 230 are classified as belonging to one of a variety of traffic flows by the uplink classifier module 257 based on inspection of one or more header and/or payload fields. The results of classification by the uplink classifier module 257 may, and in some embodiments do, affect the treatment of the classified data information, e.g., messages, packets, and/or frames, by the uplink queue management module 256 and other modules 253, 254, 255, e.g., the results may determine a particular queue the message, packet, and/or frame will be associated with for storage and further affect subsequent processing such as scheduling. The configuration information 251 may, and in some embodiments does, include configuration information, e.g., parameters settings, that affect the operation of the uplink classifier module 257, e.g., a set of one or more classifier filter rules that prescribe criteria used to associate data information, e.g., messages, packets, and/or frames, as belonging to one or more traffic flows.

The downlink PHY/MAC module 258 controls PHY layer and MAC layer processing relating to receiving data information, e.g., packets and/or frames, via the wireless communication interface module 230, e.g., from an access point to the access terminal 200. In some embodiments of the aspect, operation of the downlink PHY/MAC module 258 includes both sending and receiving control information, e.g., signals or messages, to coordinate receiving of data information, e.g., messages, packets, or frames. The configuration information 251 may, and in some embodiments does, include configuration information, e.g., parameters settings, that affect the operation of the downlink PHY/MAC module 258, e.g., a frequency, band, channel, spreading code or hoping code to be used for reception, an identifier associated with the access terminal 200, etc.

The downlink LLC (ARQ) module 259 controls LLC layer processing relating to receiving data information, e.g., packets and/or frames, via the wireless communication interface module 230, e.g., from an access point to the access terminal 200. The downlink LLC (ARQ) module 259 includes processing associated with ARQ capabilities, e.g., retransmission of lost packets or frames. In some embodiments of the aspect, the downlink LLC (ARQ) module 259 further includes processing relating to an LLC header and/or trailer that encapsulates higher layer messages, e.g., packets, which provides additional functionality, e.g., multi-protocol multiplexing/demultiplexing via a type field or error detection via a checksum field. The downlink LLC (ARQ) module 259 may also, and in some embodiments does, perform reassembly of frames received by the downlink PHY/MAC module 258 into higher layer messages, e.g., packets. The configuration information 251 may, and in some embodiments does, include configuration information, e.g., parameters settings, that affect the operation of the downlink LLC (ARQ) module 259, e.g., an ARQ window size, maximum number of retransmissions, a discard timer, etc.

The external interface module 250 controls the data received and transmitted to one or more external devices (external nodes). The external interface module 250 comprises a receiver module 252 for receiving information from an external device. The receiver module interface may be an antenna, a USB slot, Ethernet slot, etc. In aspect, the receiver module may also comprise a set of RX modules (RX processor, Demodulator, decryptor, etc.) for receiving a wireless signal, data packets and messages over the air. The external interfaces module 250, further comprises an transmitter module 254. In an aspect, the transmitter module 254 comprises a set of TX modules (TX processor, Modulator, encryptor, etc.) for transmitting a wireless signal, data packets and message over the air. In an aspect, the USB slot, Ethernet slot, etc. may be used to wirelessly communicate with the external devices.

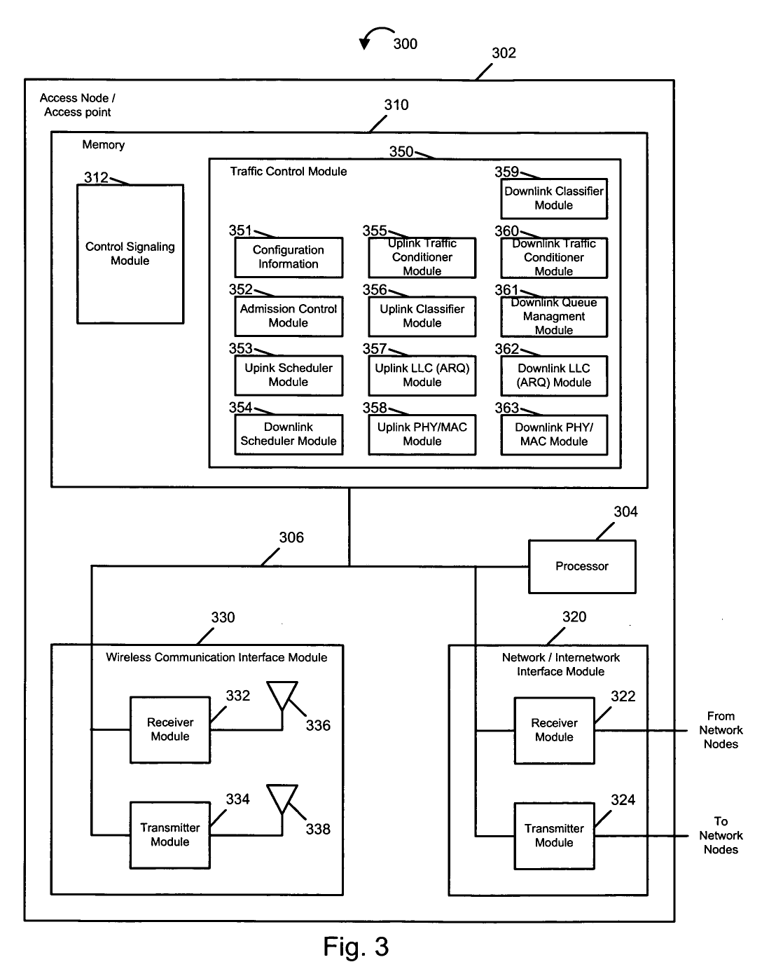

FIG. 3 provides a detailed illustration of an exemplary access point 300 implemented in accordance with the aspect of some embodiments. The exemplary access point 300, depicted in FIG. 3, is a detailed representation of an apparatus that may be used as any one of the access points 140, 140′, 140″ depicted in FIG. 1. In the FIG. 3 embodiment, the access point 300 includes a processor 304, memory 310, a network/internetwork interface module 320 and a wireless communication interface module 330, coupled together by bus 306. Accordingly, via bus 306 the various components of the access point 300 can exchange information, signals and data. The components 304, 306, 310, 320, 330 of the access point 300 are located inside a housing 302.

The network/internetwork interface module 320 provides a mechanism by which the internal components of the access point 300 can send and receive signals to/from external devices and network nodes. The network/internetwork interface module 320 includes, a receiver module 322 and a transmitter module 324 used for coupling the node 300 to other network nodes, e.g., via copper wires or fiber optic lines. The wireless communication interface module 330 also provides a mechanism by which the internal components of the access point 300 can send and receive signals to/from external devices and network nodes, e.g., access terminals. The wireless communication interface module 330 includes, e.g., a receiver module 332 with a corresponding receiving antenna 336 and a transmitter module 334 with a corresponding transmitting antenna 338. The wireless communication interface module 330 is used for coupling the access point 300 to other nodes, e.g., via wireless communication channels.

The processor 304 under control of various modules, e.g., routines, included in memory 310 controls operation of the access point 300 to perform various signaling and processing. The modules included in memory 310 are executed on startup or as called by other modules. Modules may exchange data, information, and signals when executed. Modules may also share data and information when executed. In the FIG. 3 embodiment, the memory 310 of access point 300 of the includes a control signaling module 312 and a traffic control module 350, which further includes configuration information 351 and various additional modules 352, 353, 354, 355, 356, 357, 358, 359, 360, 361, 362, and 363.

The control signaling module 312 controls processing relating to receiving and sending signals, e.g., messages, for controlling operation and/or configuration of various aspects of the access point 300 including, e.g., the traffic control module 350 as well as the configuration information 351 and the various additional modules included therein 352, 353, 354, 355, 356, 357, 358, 359, 360, 361, 362, and 363. In some embodiments of the aspect, the control signaling module 312 includes state information, e.g., parameters, status and/or other information, relating to operation of the access point 300 and/or one or more signaling protocols supported by the control signaling module 312. In particular, the control signaling module 312 may include configuration information, e.g., access point identification information and/or parameter settings, and operational information, e.g., information about current processing state, status of pending message transactions, etc.

The traffic control module 350 controls processing relating to receiving and sending data information, e.g., messages, packets, and/or frames, via the wireless communication interface module 330. The exemplary traffic control module includes configuration information 351 as well as various additional modules 352, 353, 354, 355, 356, 357, 358, 359, 360, 361, 362, and 363 that control various aspects of quality of service for packets and/or traffic flows, e.g., associated sequences of packets. In some embodiments of the aspect, the traffic control module 350 includes state information, e.g., parameters, status and/or other information, relating to operation of the access point 300, the traffic control module 350, and/or one or more of the various additional modules included therein 352, 353, 354, 355, 356, 357, 358, 359, 360, 361, 362, and 363. The configuration information 351, e.g., parameter settings, determines, affects and/or prescribes operation of the traffic control module 350 and/or the various additional modules included therein 352, 353, 354, 355, 356, 357, 358, 359, 360, 361, 362, and 363. The various additional modules are included, in some embodiments, to perform particular functions and operations as needed to support specific aspects of traffic control. In various embodiments of the aspect, modules may be omitted and/or combined as needed depending on the functional requirements of traffic control. A description of each additional module included in the exemplary traffic control module 350 follows.

The admission control module 352 maintains information relating to resource utilization/availability and determines if sufficient resources are available to support the quality of service requirements of particular traffic flows. Resource availability information maintained by the admission control module 352 includes, e.g., packet and/or frame queuing capacity, scheduling capacity, as well as processing and memory capacity needed to support one or more traffic flows. The control signaling module 312 and/or other modules included in the access point 300 may, and in some embodiments do, query the admission control module 352 to determine if sufficient resources are available to support a new or modified traffic flow, where the admission control determination is a function of the quality of service requirements of the particular traffic flow and/or the available resources. The configuration information 351 may, and in some embodiments does, include configuration information, e.g., parameters settings, that affect the operation of the admission control module 352, e.g., an admission control threshold value that indicates the percentage of resource that may be allocated prior to rejecting additional requests.

The uplink scheduler module 353 controls processing relating to transmission scheduling, e.g., order and/or timing, and allocation of transmission resources, e.g., information coding rate, transmission time slots, and/or transmission power, for data information, e.g., messages, packets, and/or frames, to be sent from one or more access terminals to the access point via the wireless interface module 330. The uplink scheduler module 353 may, and in some embodiments does, schedule transmissions and allocate transmission resources as a function of the quality of service requirements and/or constraints associated with one or more traffic flows and/or one or more access terminals. The configuration information 351 may, and in some embodiments does, include configuration information, e.g., parameters settings, that affect the operation of the uplink scheduler module 353, e.g., a priority, rate bound, latency bound, and/or sharing weight associated with one or more traffic flows and/or access terminals. In some embodiments of the aspect, scheduling and/or resource allocation operations performed by the uplink scheduler module 353 are additionally a function of channel conditions and other factors, e.g., power budget.

The downlink scheduler module 354 controls processing relating to transmission scheduling, e.g., order and/or timing, and allocation of transmission resources, e.g., information coding rate, transmission time slots, and/or transmission power, for data information, e.g., messages, packets, and/or frames, to be sent from the access point 300 to one or more access terminals via the wireless interface module 330. The downlink scheduler module 354 may, and in some embodiments does, schedule transmissions and allocate transmission resources as a function of the quality of service requirements and/or constraints associated with one or more traffic flows and/or one or more access terminals. The configuration information 351 may, and in some embodiments does, include configuration information, e.g., parameters settings, that affect the operation of the downlink scheduler module 354, e.g., a priority, rate bound, latency bound, and/or sharing weight associated with one or more traffic flows and/or access terminals. In some embodiments of the aspect, scheduling and/or resource allocation operations performed by the downlink scheduler module 354 are additionally a function of channel conditions and other factors, e.g., power budget.

The uplink traffic conditioner module 355 controls processing relating to traffic conditioning, e.g., metering, marking, policing, etc., for data information, e.g., messages, packets, and/or frames, received via the wireless interface module 330, e.g., from an access terminal to the access point 300. The uplink traffic conditioner module 355 may, and in some embodiments does, condition traffic, e.g., meter, mark and/or police, as a function of the quality of service requirements and/or constraints associated with one or more traffic flows and/or one or more access terminals. The configuration information 351 may, and in some embodiments does, include configuration information, e.g., parameters settings, that affect the operation of the uplink traffic conditioner module 355, e.g., a rate bound, and/or marking value associated with one or more traffic flows and/or access terminals.

The uplink classifier module 356 controls processing relating to identification of data information, e.g., messages, packets, and/or frames, received via the wireless interface module 330, e.g., from an access terminal to the access point 300, as belonging to particular traffic flows prior to being processed by uplink traffic conditioner module 355. In some embodiments of the aspect, messages, packets, and/or frames received via the wireless communication interface module 330 are classified as belonging to one of a variety of traffic flows by the uplink classifier module 356 based on inspection of one or more header and/or payload fields. The results of classification by the uplink classifier module 356 may, and in some embodiments do, affect the treatment of the classified data information, e.g., messages, packets, and/or frames, by the uplink traffic conditioner module 355, e.g., the results may determine a particular data structure or state machine the message, packet, and/or frame will be associated with and further affect subsequent processing such as metering, marking, and/or policing. The configuration information 351 may, and in some embodiments does, include configuration information, e.g., parameters settings, that affect the operation of the uplink classifier module 356, e.g., a set of one or more classifier filter rules that prescribe criteria used to associate data information, e.g., messages, packets, and/or frames, as belonging to one or more traffic flows.

The uplink LLC (ARQ) module 357 controls LLC layer processing relating to receiving data information, e.g., packets and/or frames, via the wireless communication interface module 330, e.g., from an access terminal to the access point 300. The uplink LLC (ARQ) module 357 includes processing associated with ARQ capabilities, e.g., retransmission of lost packets or frames. In some embodiments of the aspect, the uplink LLC (ARQ) module 357 further includes processing relating to an LLC header and/or trailer that encapsulates higher layer messages, e.g., packets, which provides additional functionality, e.g., multi-protocol multiplexing/demultiplexing via a type field or error detection via a checksum field. The uplink LLC (ARQ) module 357 may also, and in some embodiments does, perform reassembly of frames received by the uplink PHY/MAC module 358 into higher layer messages, e.g., packets. The configuration information 251 may, and in some embodiments does, include configuration information, e.g., parameters settings, that affect the operation of the uplink LLC (ARQ) module 357, e.g., an ARQ window size, maximum number of retransmissions, a discard timer, etc.

The uplink PHY/MAC module 358 controls PHY layer and MAC layer processing relating to receiving data information, e.g., packets and/or frames, via the wireless communication interface module 330, e.g., from an access terminal to the access point 300. In some embodiments of the aspect, operation of the uplink PHY/MAC module 358 includes both sending and receiving control information, e.g., signals or messages, to coordinate receiving of data information, e.g., messages, packets, or frames. The configuration information 351 may, and in some embodiments does, include configuration information, e.g., parameters settings, that affect the operation of the uplink PHY/MAC module 358, e.g., a frequency, band, channel, spreading code or hoping code to be used for reception, an identifier associated with the access point 300, etc.

The downlink classifier module 359 controls processing relating to identification of data information, e.g., messages, packets, and/or frames, as belonging to particular traffic flows prior to being sent via the wireless communication interface module 330, e.g., from the access point 300 to an access terminal. In some embodiments of the aspect, messages, packets, and/or frames to be sent via the wireless communication interface module 330 are classified as belonging to one of a variety of traffic flows by the downlink classifier module 359 based on inspection of one or more header and/or payload fields. The results of classification by the downlink classifier module 359 may, and in some embodiments do, affect the treatment of the classified data information, e.g., messages, packets, and/or frames, by the downlink queue management module 361 and other modules 360, 362, 363, e.g., the results may determine a particular queue the message, packet, and/or frame will be associated with for storage and further affect subsequent processing such as scheduling. The configuration information 351 may, and in some embodiments does, include configuration information, e.g., parameters settings, that affect the operation of the downlink classifier module 359, e.g., a set of one or more classifier filter rules that prescribe criteria used to associate data information, e.g., messages, packets, and/or frames, as belonging to one or more traffic flows.

The downlink traffic conditioner module 360 controls processing relating to traffic conditioning, e.g., metering, marking, policing, etc., for data information, e.g., messages, packets, and/or frames, to be sent via the wireless interface module 330, e.g., from the access point 300 to an access terminal. The downlink traffic conditioner module 360 may, and in some embodiments does, condition traffic, e.g., meter, mark and/or police, as a function of the quality of service requirements and/or constraints associated with one or more traffic flows and/or one or more access terminals. The configuration information 351 may, and in some embodiments does, include configuration information, e.g., parameters settings, that affect the operation of the downlink traffic conditioner module 360, e.g., a rate bound, and/or marking value associated with one or more traffic flows and/or access terminals.

The downlink queue management module 361 maintains information and controls processing relating to storage of data information, e.g., messages, packets, and/or frames, to be sent via the wireless communication interface module 330, e.g., from the access point 300 to an access terminal. The downlink queue management module 361 may, and in some embodiments does, control storage of data information awaiting transmission and maintain state information regarding data information awaiting transmission on a per traffic flow basis, e.g., packets associated with each traffic flow may be stored in separate queues. In some embodiments of the aspect, the downlink queue management 361 module supports a variety of queue management techniques and/or capabilities, e.g., head drop, tail drop, as well as various AQM mechanisms such as RED. The configuration information 351 may, and in some embodiments does, include configuration information, e.g., parameters settings, that affect the operation of the downlink queue management module 361, e.g., a queue limit, drop strategy, and/or AQM thresholds associated with one or more traffic flows.

The downlink LLC (ARQ) module 362 controls LLC layer processing relating to sending data information, e.g., messages, packets, and/or frames, via the wireless communication interface module 330, e.g., from the access point 300 to an access terminal. The downlink LLC (ARQ) module 362 includes processing associated with ARQ capabilities, e.g., retransmission of lost packets or frames. In some embodiments of the aspect, the downlink LLC (ARQ) module 362 further includes processing relating to the addition of an LLC header and/or trailer to higher layer messages, e.g., packets, to provide additional functionality, e.g., multi-protocol multiplexing/demultiplexing via a type field or error detection via a checksum field. The downlink LLC (ARQ) module 362 may also, and in some embodiments does, perform fragmentation of higher layer messages, e.g., packets, into multiple sub-portions, e.g., frames to be sent by the downlink PHY/MAC module 363. The configuration information 351 may, and in some embodiments does, include configuration information, e.g., parameters settings, that affect the operation of the downlink LLC (ARQ) module 362, e.g., an ARQ window size, maximum number of retransmissions, a discard timer, etc.

The downlink PHY/MAC module 363 controls PHY layer and MAC layer processing relating to sending data information, e.g., messages, packets, and/or frames, via the wireless communication interface module 330, e.g., from the access point 300 to an access terminal. In some embodiments of the aspect, operation of the downlink PHY/MAC module 363 includes both sending and receiving control information, e.g., signals or messages, to coordinate sending of data information, e.g., messages, packets, or frames. The configuration information 351 may, and in some embodiments does, include configuration information, e.g., parameters settings, that affect the operation of the downlink PHY/MAC module 363, e.g., a frequency, band, channel, spreading code or hoping code to be used for transmissions, an identifier associated with the access point 300, etc.

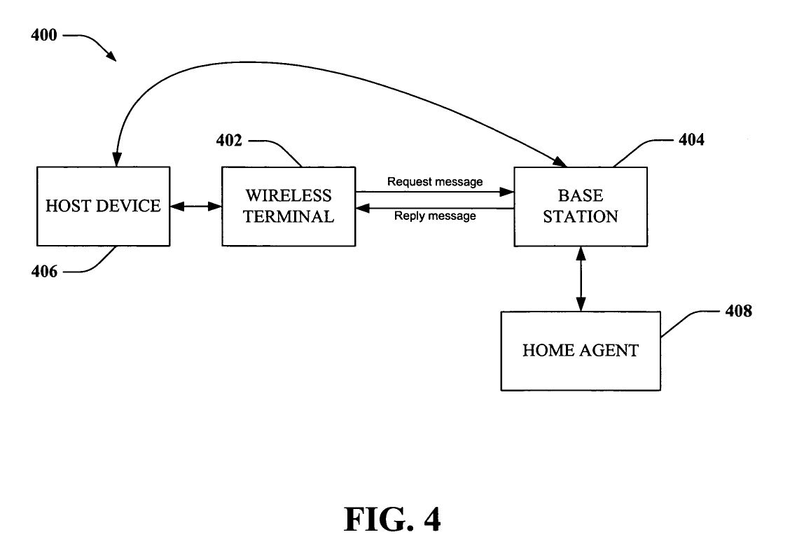

Referring now to FIG. 4, a system 400 that is provided to illustrate configuration of a host device through utilization of a Mobility Management Protocol (MMP), which, for instance, can be a “scaled down” protocol that is based at least in part upon Mobile IP (a protocol commonly utilized to transmit configuration data between a host, a base station, and other network infrastructure devices). Several example data structures are provided and described herein that may be, but are not required to be, utilized in connection with MMP. Rather, such data structures are shown solely to illustrate one or more examples, and it is to be appreciated that other data structures that are based at least in part upon MIP are contemplated by the inventors and intended to fall under the scope of the hereto-appended claims.

System 400 includes a wireless terminal 402, which can be, for example, an integrated chip within a mobile handset, a secure digital (SD) card, a device that is physically coupled to a computer (e.g., laptop, desktop, . . . ), such as a card that can be inserted into a PCMCIA slot, or any other suitable device that can aid in wireless communications. Wireless terminal 402 can be tasked to establish a wireless link with a base station 404, thereby enabling data to be transferred between wireless terminal 402 and base station and/or a host device 406 and base station 404. Host device 406 can be a device that hosts wireless terminal 402, such as a personal digital assistant, a mobile telephone, a computer, or any other suitable host device. Host 406 can include, for example, an IP stack, enabling host 406 to run applications over IP.

Base station 404 is communicatively coupled to home agent 408, which can be employed in connection with mobility management. In other words, home agent 408 allows host 406 and terminal 402 to change geographic location within a wireless network without losing an ability to receive and transmit data. Wireless terminal 402 and base station 404 can undertake messaging to establish a physical layer connection therebetween, and authentication and authorization can also be undertaken to discern what services a subscriber is authorized to access. In accordance with authorization and authentication, a connect response message can be provided from base station 404 to wireless terminal 402, wherein such message can include data that can be utilized to identify base station 404 on the network.

Wireless terminal 402 can then provide a message, for instance, that accords to MMP, wherein such message indicates that an initial registration of an IP address is desired. As stated above, utilizing MMP reduces an amount of data that is transmitted over an OTA link, which typically is a link that is associated with constrained resources. Upon receiving the initial registration message, base station 404 can request an initial IP address and other suitable configuration information from home agent 408, wherein such request can conform to MIP, for example. Home agent 408 can then provide a response that includes a home address to base station 404, wherein the home address can be an IP address that is to be assigned to host device 406.

Wireless terminal 402 can thereafter inform host device 406 that a link is prepared over a wireless terminal interface (WTI), but host device 406 can be unaware that an IP address has been assigned by home agent 408. Host device 406 can be triggered to run the Dynamic Host Configuration Protocol (DHCP) and generate a DHCP discover message and relay it over the link. Base station 404 can be configured to operate as a DHCP server, and can respond to such request to host device 406 (again by way of DHCP). Host device 406 can thereafter provide a request for an IP address to base station 404, and base station 404 can provide host device 406 with the requested IP address and other suitable configuration information.

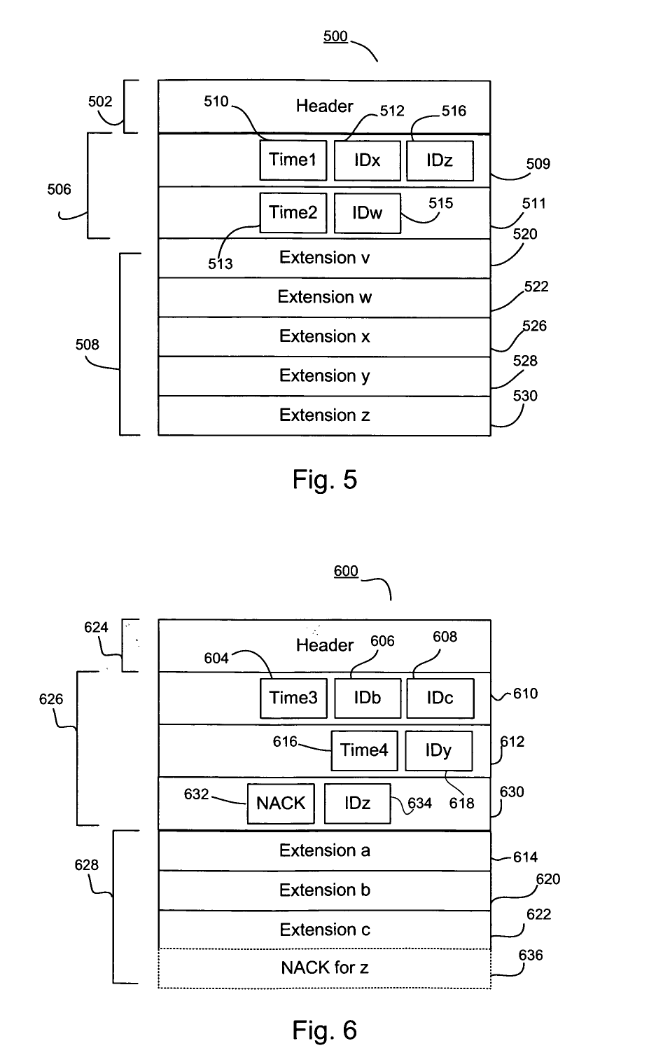

FIG. 5 illustrates a time sync request (Req) message 500 according to an aspect of some embodiments. Req message comprises a header portion 502, a sync portion 506 and an extension portion 508. In an aspect, the header portion 502 comprises a transaction ID. The transaction ID may be used to match the reply message discussed below.

In an aspect, the sync portion 506 comprises one or more objects (for example sync portion A 509 and sync portion B 511). Depending on the number of different selected times required for synchronization, the number of objects attached to the Req message 500 will vary. Each object comprises a time value and one or more index values. As an example, FIG. 5 shows sync portion A as having a time value (Time1) 510 and two index values (IDx and IDz) 513 and 515.

In an aspect, the extension portion comprises one or more extensions. Depending upon the number of parameter that need time synchronization, the number of extensions attached to the Req message 500 will vary. As an example, the extension portion 508 comprises extension 520, extension 522, extension 526, extension 528 and extension 530, wherein each extension is indexed (having a index value based on location of the extension in extension portion) and may comprise one or more fields providing parameter information.

FIG. 6 illustrate a time sync response (Resp) message 600 according to an aspect of some embodiments. Resp message 600 comprises a header portion 624, a sync portion 626 and an extension portion 628. In aspect, the header portion 624 comprises a transaction ID. The transaction ID may be the same value as the transaction ID used for the Req message 500. Thus, the processor receiving the Resp message 600 may match the Resp message 600 to a previously transmitted Req message 500.

In an aspect, the sync portion 626 comprises one or more objects (for example sync portion A 610 and sync portion B 612). Depending on the number of different selected times required for synchronization or the number time sync responses require to be supplied, the number of objects attached to the Resp message 600 will vary. Each object comprises a time value and one or more index values. As an example, FIG. 6 shows sync portion A has having a time value (Time1) 604 and two index values (IDb and IDc) 606 and 608. The sync portion may also be used to provide time of activation for parameters that did not have a selected time in the Req message 500. Also, the sync portion C 630 may be used provide a negative acknowledgement of time request for one or more parameters, wherein sync portion C 630 comprises a response value 632 (for example, NACK) and an index value 634 of the parameter that is rejected.

In an aspect, the extension portion comprises one or more extensions. Depending upon the number of parameter that need time synchronization, the number of extension attached to the Resp message 600 will vary. As an example, the extension portion 628 comprises extension 614, extension 620 and extension 622, wherein each extension is indexed and may comprise one or more fields providing parameter information. In another aspect, instead of using sync portion C 630 for providing a rejection to time synchronization request, a rejection extension 636 may be used for the rejected parameter.

In another aspect, the sync portion C 630 may be attached sync portion 506 of Req message 500 and extension 636 may be attached to extension portion 508 or message 500.

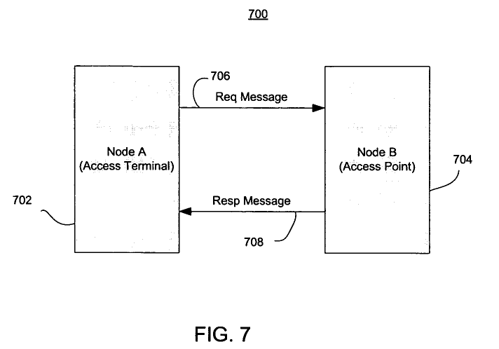

FIG. 7 illustrates a signaling flow between two nodes according to an aspect of the some embodiments. For example, when processor of Node A (e.g. base station, mobile terminal, home agent server, router, access point, etc.) 702 has determined that parameter x and parameter z require synchronization at selected time Time1, parameter w require time synchronization at selected time Time2, and require time to be selected by Node B (e.g. base station, mobile terminal, home agent server, router, access point, etc.) 704 for parameters v and y, the processor will generate a Req message 500 for transmitting to Node B 706. The processor for Node A 702 will construct a request message signal 706 using various known techniques and transmit the request message signal 706 to Node B 704.

Upon receiving the message signal 706, by the processor of Node B 704, the processor of Node B 704 will process the message signal 706. The processor will deconstruct and extract information from the request message signal 706. After deconstructing and extracting the information from the message signal 706, the Resp message 500 is generated and transmitted to device (for example Node A 702) that sent the message signal 706. The processor for Node B 704 will construct a response message signal 708 using various known techniques and transmit the response message signal 708 to Node A 702.

In an aspect, processor for Node A 702 and processor for Node B 704 are configured to construct and deconstruct message signals to add or extract the Req message 500 or Resp message 500, respectively. In another aspect, processor for Node A 702 and processor for Node B 704 are configured to construct and deconstruct message signals to add or extract the Req message 500 having the sync portion C and/or extension 636.

For example, the processor is configured to use sync portion A to request a time of activation for parameter x and parameter z at time Time1. The processor will attach an extension for parameter x 526 to the extension portion 508 and will set the index value 512 to represent the location of extension 526 in the extension portion. Also, processor will attach an extension for parameter z 530 to the extension portion 508 and will set the index value 516 to represent the location of extension 530 in the extension portion. Also, processor will attach an extension for parameter w 522 to the extension portion 508 and will set the index value 515 to represent the location of extension 522 in the extension portion. For parameters v and y, since time is not selected, the processor will not attach any objects to sync portion, but instead will attach extension for parameter y 528 and extension for parameter v 520 to the extension portion 508. Upon setting up the Req message, the processor is configured to transmit the message to a node (for example, base station) and await a reply message that matches the transaction id of this message.

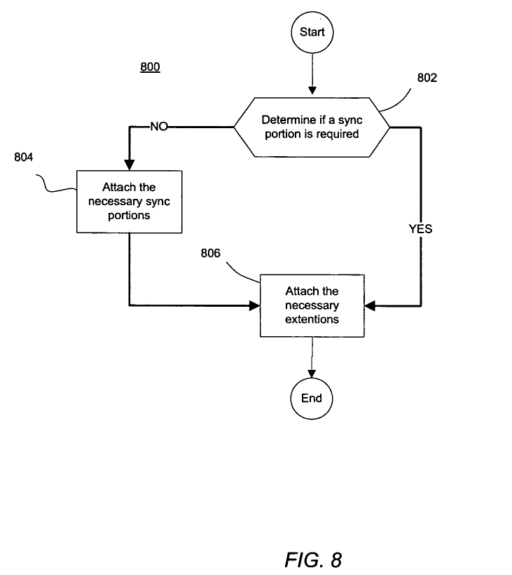

FIG. 8 illustrates a flow of a routine 800 according to an aspect of some embodiments. In an aspect, the processor of a requesting node (e.g. Node A 702) is configured to execute the routine 800 upon determining that one or more parameters needs to be negotiated. At block 802, the processor determines if the sync portion 506 of the Req message 500 needs to be constructed. This determination may be based on various factors. In an aspect, if processor determines that one or more pre-selected activation time is preferred for one or more parameters, then a sync portion is attached for each pre-selected time at block 804. For example, sync portion A 509 is attached to sync portion 506 for parameters x and z having pre-select time Time1 and sync portion B 511 is attached to sync portion 506 for parameters w having pre-select time Time2. The actual values may be set after the message is built or as it is being built. In an aspect, the time value 510 and 513 are set to Time1 and Time2, respectively. The index value may be set after the attachment of the extensions.

At block 806, the processor attaches the necessary extensions to the extension portion 508. If block 806 is executed, then an extension for each parameter is attached to the extension portion 508 of Req message 500. For example, extension 522 for parameter w, extension 526 for parameter x and extension 530 for parameter z are attached. The index values 512, 516, and 515 are set based on location of extension associated with parameters x, z and w, respectively. In addition, an extension is added for each parameter, wherein no pre-selected time of activation is designated, but the time of activation will be supplied by another node. For example, extensions 520 and 528 are added for parameters v and y, respectively. The index value for extensions 520 and 528 are stored in memory and is associated with the transaction ID of the transmitted message. The processor completes the construction of the request message and transmits the request message. After the transmission of the request message, the processor awaits for a reply before using the parameters.

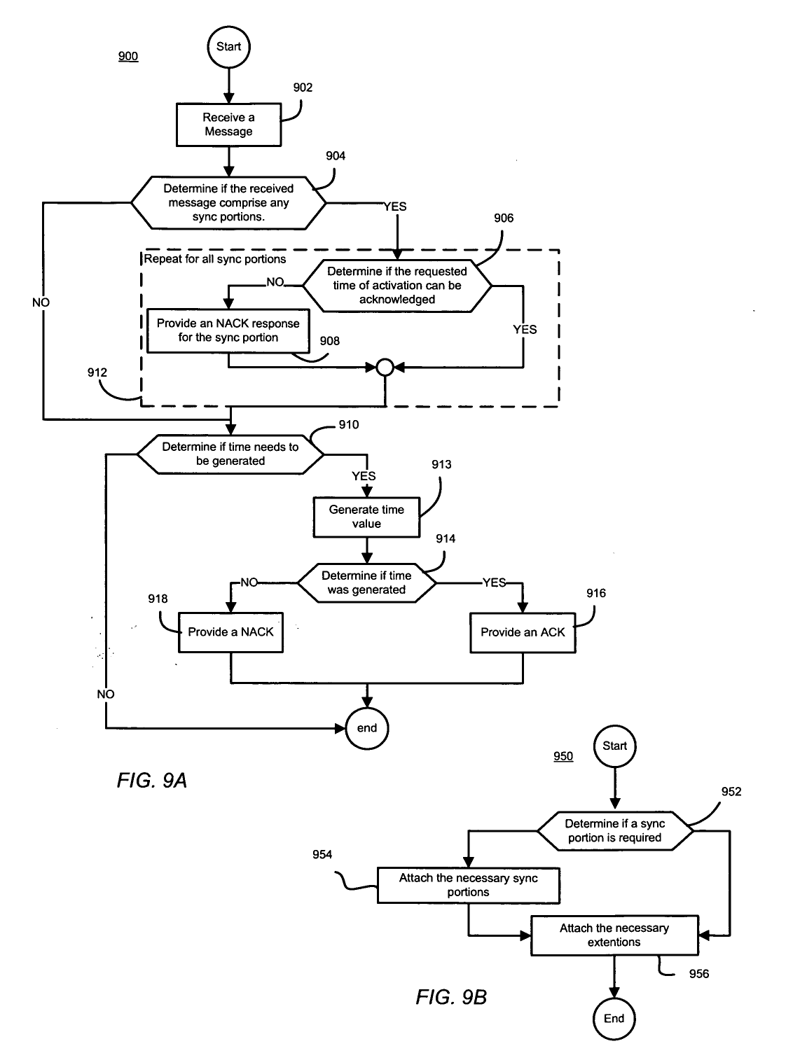

FIG. 9 illustrates a flow of a routine 900 according to an aspect of some embodiments. The processor of the requested node (i.e. Node B) is configured to execute the routine 900 upon receiving a request message from at least one node (for example, a mobile terminal). At block 902, the processor receives a message from another node (i.e. Node A). At block 904, the processor determines if the received message comprise any sync portions. If so, then at block 906, for each sync portion (repeat loop 912), determine if the requested time (for example, Time1 for parameters x and z) of activation can be acknowledged (i.e. accepted). If not, at block 908, the processor provides a NACK response for the sync portion for which the time value was not accepted or rejected. In an aspect, the processor generates either an extension or sync portion for a Resp message. As an example, for parameter z, it is determined that the requested time Time2 can not be complied or accepted. Here, the processor will generate sync portion comprising a response value 632 and index value 634, and provide a NACK value for response value 632 and index value based on the location of extension associated with parameter v in the extension portion of the received message. In another aspect, the processor will generate an extension, for example extension 636 for parameter z, and indicated within the extension that requested time value was rejected.

Referring back to block 906, in an aspect, if the requested time of activation is accepted, then no sync portion is generated. This will reduce the processing overhead and allow the requesting node (i.e. Node A) to conclude requested time of activation was accepted. In another aspect, the processor will generate sync portion comprising a response value 632 and index value 634, and provide an ACK value for response value 632 and index value based on the location of extension associated with, for example, parameter x in the extension portion of the received message.

At block 910, the processor determines if time needs to be generated. If there are any extensions attached to the extension portion 628 that are not associated with a sync portion (for example, extension 528 for parameter y), the processor needs to generate a time of activation and provide that time to requesting node (i.e. Node A). If determined that there is at least one extension that require the processor to generate a time (i.e. Time4), then at block 913, the processor attempts to generate a time value. At block 914, determine if the processor was able to generate a time value. If the time value and the parameter value are accepted, then the processor stores in memory an indication that an ACK will be provided. If is ACK is to be provided, then at block 916, the processor provides an ACK by generating a sync portion, for example sync portion B 612 and set the time value 616 to the generated time (i.e. Time4) and attaching the sync portion B 612 to the Resp message 600. The index value for will be set to index value of the parameter's (for example, parameter y) location in extension portion of the Req message 500. However, if the processor was not able to generate a time value or accept a parameter value, then at block 918 the processor must reject (i.e provide a NACK) the request. If request is rejected, the processor generates a sync portion or an extension and provides an indication (for example, adding a sync portion and setting the response value to NACK and index value to the location of the extension associated with parameter in extension portion 508 of the Req message 500) that the request was rejected. In another aspect, the processor may generate an extension and indicated within the extension that requested time value was rejected.

In an aspect of a communication system, Node B (i.e. base station) is configured to negotiate new parameters with Node A (i.e. mobile station) using the Resp message 600. FIG. 9B illustrates a flow of a routine 950 according to an aspect of some embodiments. In an aspect, the processor of a requested node (e.g. Node B 702) is further configured to execute the routine 950 upon determining that one or more parameter needs to be negotiated. At block 952, the processor determines if the sync portion 626 of the Req message 500 need to be constructed. This determination may be based on various factors. In an aspect, if processor determines that one or more pre-selected activation time is preferred for one or more parameters, then a sync portion is attached for each pre-selected time. For example, sync portion A 610 is attached to sync portion 626 for parameters b and c having pre-select time Time3. The actual values may be set after the message is built or as it is being built. In an aspect, the time value 604 Time3. The index value may be set after the attachment of the extensions.

At block 956, the processor attaches the necessary extensions to the extension portion 626. If block 856 is executed, then an extension for each parameter is attached to the extension portion 628 of Resp message 500. For example, extension 620 for parameter b and extension 622 for parameter c are attached. The index values 606 and 608 are set based on location of extension associated with parameters x, z and w, respectively. In addition, additional extensions may be added for each parameter, wherein no pre-selected time of activation is designated, but the time of activation will be supplied by another node. The processor completes the construction of the response message and transmits the response message to requesting node (i.e. Node A). After the transmission of the response message, the processor awaits for a reply, if any new parameters were added.

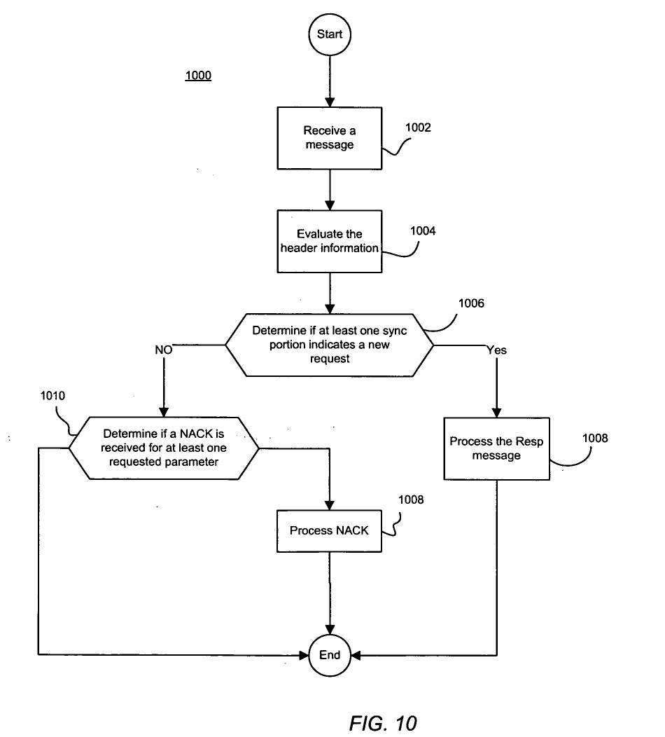

FIG. 10 illustrates a flow routine 1000 for processing reply to request for synchronization. In an aspect, the processor of requesting node (e.g. Node A) is configured to execute the routine 1000. At block 1002 the processor receives the Resp message 600 from requested node (e.g. Node B). At block 1004, the processor of Node A evaluates the header portion to determine the transaction ID. At 1006, if determined that at least one sync portion comprises a new request for parameter negotiation, then at block 1008, the processor may execute instructions stated in flow routine 900 of FIG. 9A, starting with block 904. However, the exchange between node A and node B is swapped. In an aspect, the processor may also, execute instructions stated in flow routine 950 of FIG. 9B. In another aspect, the processor may execute instructions stated in flow routine 800 of FIG. 8.

Referring back to block 1006, if determined that there are no sync portions that require new parameter negotiations, then at block 1010, the processor determines if a NACK is received in the sync portion 626 of the Resp message 600. If no NACK is received, then processor assumes that all the time synchronization requests were accepted. Otherwise, at block 1012 the processor processes the NACK response.

In another aspect, the processor checks all the sync portions (for example, 610, 612, and 630) of sync portion 626 to determine the appropriate actions. For example, the processor may evaluate each sync portions of sync portion of 626 to determine if the ACK, NACK or new requests are received.

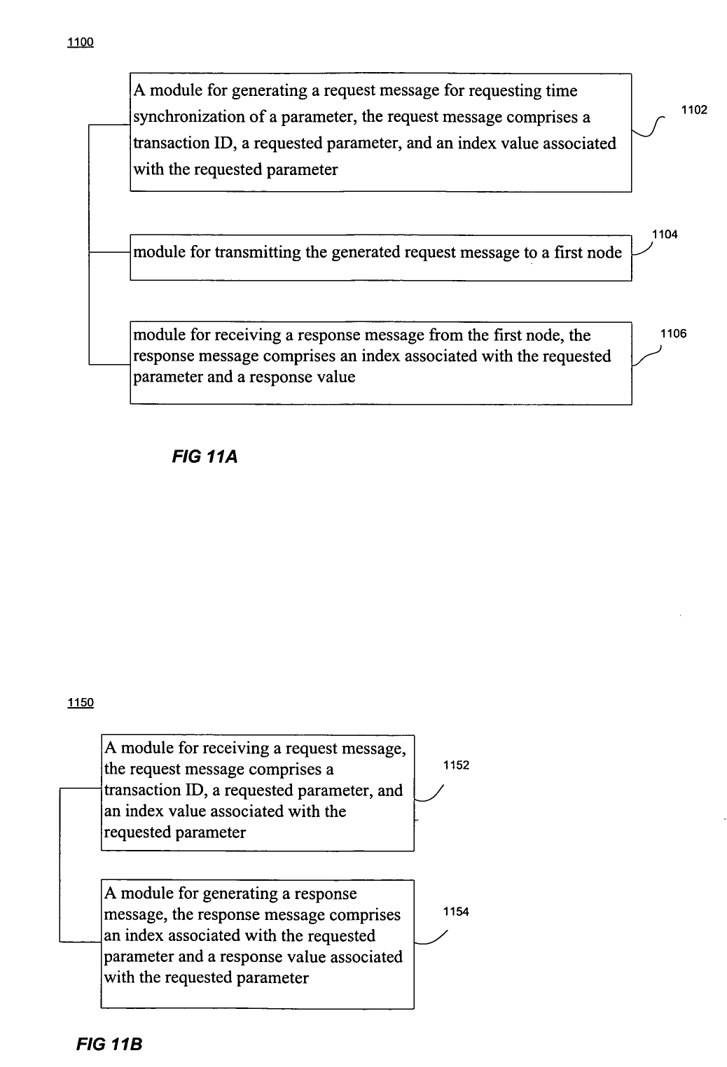

FIG. 11A and FIG. 11B illustrates the use of one or more modules to carry out the methodologies 1100 and 1150 according to an aspect of some embodiments. The modules referred to in FIG. 11A and FIG. 11B may be an electronic devices, processors, hardware devices, storage mediums, etc. or any combination thereof. Referring to FIG. 11A, in an aspect, an apparatus comprises means for generating a request message for requesting time synchronization of a parameter, the request message comprises a transaction ID, a requested parameter, and an index value associated with the requested parameter; means for transmitting the generated request message to a first node; and means for receiving a response message from the first node, the response message comprises an index associated with the requested parameter and a response value. The means for generating may be a module as described by 1102 of FIG. 11A. The means for transmitting may be a module as described by 1104 of FIG. 11A and the means for receiving may comprise a module as described by 1106 of FIG. 11A.

Referring to FIG. 11B, in another aspect, an apparatus comprises means for receiving a request message, the request message comprises a transaction ID, a requested parameter, and an index value associated with the requested parameter, wherein the means comprises a module as described by 1152 of FIG. 11B. The apparatus further comprising means for generating a response message, the response message comprises an index associated with the requested parameter and a response value associated with the requested parameter, wherein the means comprises a module as described by 1154 of FIG. 11B.

Messages described in the present patent application are stored in the memory of the nodes which generate and/or receive said messages in addition to the nodes through which said messages are communicated. Accordingly, in addition to being directed to methods and apparatus for generating, transmitting and using novel messages, the aspects are also directed to machine readable media, e.g., memory, which stores one or more of the novel messages of the type described and shown in the text and figures of the present application.

In various embodiments, nodes described herein are implemented using one or more modules to perform the steps corresponding to one or more methods of the aspect, for example, signal processing, message generation and/or transmission steps. Thus, in some embodiments various features of the are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, the aspect is directed to a machine-readable medium including machine executable instructions for causing a machine, e.g., processor 304 and associated hardware, to perform one or more of the steps of the above-described method(s).

Numerous additional variations on the methods and apparatus of the aspects described above will be apparent to those skilled in the art in view of the above description of the aspect. Such variations are to be considered within the scope of the aspect. The methods and apparatus of the aspects may be, and in various embodiments are, used with OFDM, CDMA, TDMA or various other types of communications techniques which may be used to provide wireless communications links between access nodes and mobile nodes. In some embodiments the access nodes are implemented as base stations which establish communications links with mobile nodes using OFDM, CDMA and/or TDMA. In various embodiments the mobile nodes are implemented as notebook computers, PDAs, or other portable devices including receiver/transmitter circuits and logic and/or routines, for implementing the methods of the aspects described above.

What is claimed is:

1. An apparatus for time synchronizing one or more parameters in a communication system, the apparatus comprising:
means for generating a request message for requesting time synchronization of a parameter, the request message comprises a transaction ID, a requested parameter, and an index value associated with the requested parameter;
means for transmitting the generated request message to a first node; and
means for receiving a response message from the first node, the response message comprises an index associated with the requested parameter and a response value.

2. The apparatus as claimed in claim 1, wherein the request message further comprises one or more additional requested parameters and one or more additional index which are values associated with the additional parameters.

3. The apparatus as claimed in claim 1, wherein the request message further comprises a requested activation time indicating when use of the requested parameter should take effect.

4. The apparatus as claimed in claim 2, wherein the response value indicates a negative acknowledgement.

5. The apparatus as claimed in claim 2, wherein the response value indicates a positive acknowledgement.

6. The apparatus as claimed in claim 1, wherein the response message further comprises a second request parameter and a second index which is associated with the second request parameter.

7. The apparatus as claimed in claim 6, further comprising:
means for generating time value when the second request parameter can be used; and
means for transmitting the time value to first node.

8. The apparatus as claimed in claim 1, wherein the response value indicates a time value.

9. An apparatus for time synchronizing one or more parameters in a communication system, the apparatus comprising:
means for receiving a request message, the request message comprises a transaction ID, a requested parameter, and an index value associated with the requested parameter; and
means for generating a response message, the response message comprises an index associated with the requested parameter and a response value associated with the requested parameter.

10. The apparatus as claimed in claim 9, wherein means for generating the response message comprises:
means for generating a time value when the requested parameter can be used; and
means for transmitting the time value.

11. The apparatus as claimed in claim 9, wherein the response value indicates a negative acknowledgement.

12. The apparatus as claimed in claim 9, wherein the response value indicates a positive acknowledgement.

13. The apparatus as claimed in claim 9, wherein the response message further comprises a second request parameter and a second index associated with the second parameter.

14. A method for time synchronizing one or more parameters in a communication system, the method comprising:
generating a request message for requesting time synchronization of a parameter, the request message comprises a transaction ID, a requested parameter, and an index value associated with the requested parameter;
transmitting the generated request message to a first node; and
receiving a response message from the first node, the response message comprises an index associated with the requested parameter and a response value.

15. The method as claimed in claim 14, wherein generating the request message comprises generating a plurality of additional requested parameters and a plurality of additional index values which are associated with the additional parameters.

16. The method as claimed in claim 14, wherein generating the request message comprises generating a requested activation time indicating when use of the requested parameter should take effect.

17. The method as claimed in claim 15, wherein receiving the response value comprises receiving a negative acknowledgement.

18. The method as claimed in claim 15, wherein receiving the response value comprises receiving a positive acknowledgement.

19. The method as claimed in claim 14, wherein receiving the response message further comprises receiving a second request parameter and a second index which is associated with the second request parameter.

20. The method as claimed in claim 19, further comprising:
generating time value when the second request parameter can be used; and
transmitting the time value to first node.

21. The method as claimed in claim 14, wherein receiving the response value comprises receiving a time value.

22. The method for time synchronizing one or more parameters in a communication system, the method comprising:
receiving a request message, the request message comprises a transaction ID, a requested parameter, and an index value associated with the requested parameter; and
generating a response message, the response message comprises an index associated with the requested parameter and a response value associated with the requested parameter.

23. The method as claimed in claim 22, wherein generating the response message comprises:
generating a time value when the requested parameter can be used; and
transmitting the time value.

24. The method as claimed in claim 22, wherein generating the response value comprises generating a negative acknowledgement.

25. The method as claimed in claim 22, wherein the response value comprises generating a positive acknowledgement.

26. The method as claimed in claim 22, wherein generating the response message further comprises generating a second request parameter and a second index value which is associated with the second parameter.

27. A machine-readable medium comprising instructions which, when executed by a machine, cause the machine to perform operations including:
generating a request message for requesting time synchronization of a parameter, the request message comprises a transaction ID, a requested parameter, and an index value associated with the requested parameter;
transmitting the generated request message to a first node; and
receiving a response message from the first node, the response message comprises an index associated with the requested parameter and a response value.

28. The machine-readable medium as claimed in claim 27, wherein generating the request message comprises generating a plurality of additional requested parameters and a plurality of additional index values which are associated with the additional parameters.

29. The machine-readable medium as claimed in claim 27, wherein generating the request message comprises generating a requested activation time indicating when use of the requested parameter should take effect.

30. A machine-readable medium comprising instructions which, when executed by a machine, cause the machine to perform operations including:
receiving a request message, the request message comprises a transaction ID, a requested parameter, and an index value associated with the requested parameter; and
generating a response message, the response message comprises an index associated with the requested parameter and a response value associated with the requested parameter.

31. The machine-readable medium as claimed in claim 27, wherein generating the response message comprises:
generating a time value when the requested parameter can be used; and
transmitting the time value.

32. The machine-readable medium as claimed in claim 27, wherein the response message further comprises generating a second request parameter and a second index associated with the second parameter.

33. An apparatus operable in a communication system, the apparatus comprising:
a processor configured to generate a request message for requesting time synchronization of a parameter, the request message comprises a transaction ID, a requested parameter, and an index value associated with the requested parameter; the processor configured to transmit the generated request message to a first node; and the processor further configured to receive a response message from the first node, the response message comprises an index associated with the requested parameter and a response value.

34. The apparatus as claimed in claim 33, wherein the processor configured to generate a plurality of additional requested parameters and a plurality of additional index values which are associated with the additional parameters.

35. The apparatus as claimed in claim 33, wherein the processor configured to generate the request message comprises generating a requested activation time indicating when use of the requested parameter should take effect.

36. An apparatus operable in a communication system, the apparatus comprising:
a processor configured to receive a request message, the request message comprises a transaction ID, a requested parameter, and an index value associated with the requested parameter; and the processor configured to generating a response message, the response message comprises an index associated with the requested parameter and a response value associated with the requested parameter.

37. The apparatus as claimed in claim 36, wherein the processor further configured to:
generate a time value when the requested parameter can be used; and
transmit the time value.

38. The apparatus as claimed in claim 36, wherein the processor further configured to generate a second request parameter and a second index associated with the second parameter.

39. An apparatus operable in a communication system, the apparatus comprising:
a processor, configured to generate a request message for requesting time synchronization of a parameter, the request message comprises a transaction ID, a requested parameter, and an index value associated with the requested parameter; the processor configured to transmit the generated request message to a first node; and the processor further configured to receive a response message from the first node, the response message comprises an index associated with the requested parameter and a response value; and
a memory coupled to the processor and memory used for storing the transaction ID, the requested parameter, and the index value.

40. The apparatus as claimed in claim 39, wherein the apparatus comprises an access terminal, the access terminal comprises a user interface.

41. An apparatus operable in a communication system, the apparatus comprising:
a processor configured to receive a request message, the request message comprises a transaction ID, a requested parameter, and an index value associated with the requested parameter; and the processor configured to generating a response message, the response message comprises an index associated with the requested parameter and a response value associated with the requested parameter.

42. The apparatus as claimed in claim 39, wherein the processor and memory are incorporated in an access point.
